(19) United States
(12) Patent Application Publication
(10) Pub. No.: US 2011/0141032 A1
(43) Pub. Date: Jun. 16, 2011

(54) Electro-optic display and related driving method thereof

(76) Inventors: Wei-Ting LIU, Hacienda Heights, CA (US); Wei-Hua LU, Taipei (TW); Chih-Kuei HU, Jubei (TW)

(21) Appl. No.: 12/639,945

(22) Filed: Dec. 16, 2009

(51) Int. Cl. G06F 3/041

(52) U.S. Cl. 345/173

(57) ABSTRACT

The present invention discloses an electro-phoretic display. The electro-phoretic display includes an electro-phoretic panel, a touch sensing module, for sensing a touch position, a column driver, a row driver, for selecting a row to be driven; and a controller, for determining an updating position according to the touch position; wherein, the column driver provides a data signal according to the updating position and the row driver provides a selecting signal according to the updating position such that a pixel corresponding to the updating position is updated.

### BACKGROUND OF THE INVENTION

1. Field of the Invention

The present invention relates to an electro-phoretic display, and more particularly, to an electro-phoretic touch display.

2. Description of the Prior Art

It has been suggested that electro-optical elements for converting an electrical action into an optical action be used as display devices of various types of electronic apparatuses, such as monitor, mobile phone or PDAs (Personal Digital Assistants). Electro-phoretic displays comprise a layer of electro-phoretic material, a term which is used herein in its conventional meaning in the imaging art to refer to a material having first and second display states differing in at least one optical property, the material being changed from its first to its second display state by application of an electric field to the material.

To obtain a high resolution electro-phoretic display, a two-dimensional addressing scheme with a plurality of data lines and a plurality of select lines is a way to achieve that requirement. In this scheme, each pixel being defined by the intersection of one data line and one select line. A pixel is connected via a non-linear element (transistor or diode) to drive circuitry used to control the operation of the display. One row (it is here assumed that the select lines define the rows of the matrix and the data lines define the columns, but obviously this is arbitrary, and the assignments could be reversed if desired) of pixels is selected by applying a voltage to a specific select line, and the voltages on the data or column lines are adjusted to provide the desired optical response from the pixels in the selected row. The pixel electrodes in the selected row are thus raised to voltages which is close to but (for reasons explained below) not exactly equal to the voltages on their associated data lines. The next row of pixels is then selected by applying a voltage to the next select line, so that the entire display is written on a row-by-row basis.

When the non-linear elements are transistors (typically thin film transistors (TFT's)), it is conventional practice to place the data and select lines, and the transistors, on one side of the electro-phoretic medium, and to place a single common electrode, which extends across numerous pixels, and typically the whole display, on the opposed side of the electro-phoretic medium. The common electrode is normally provided on the viewing surface of the display (i.e., the surface of the display which is seen by an observer). During writing of the display, the common electrode is held at a fixed voltage, known as the “common electrode voltage” or “common plane voltage” and usually abbreviated “V.sub.COM”. This common plane voltage may have any convenient value, since it is only the differences between the common plane voltage and the voltages applied to the various pixel electrodes which affects the optical states of the various pixels of the electro-phoretic medium. Most types of electro-phoretic media are sensitive to the polarity as well as the magnitude of the applied field, and thus is necessary to be able to drive the pixel electrodes at voltages both above and below the common plane voltage. For example, the common plane voltage could be 0, with the pixel electrodes varying from −V to +V, where V is any arbitrary maximum voltage. Alternatively, it is common practice to hold the common plane voltage at +V/2 and have the pixel electrodes vary from 0 to +V.

One important application of electro-phoretic media is in portable electronic devices, where battery life is an important consideration, and thus it is desirable to reduce the power consumption of the display as far as possible. Liquid crystal displays are not bistable, and hence an image written on such a display must be constantly refreshed if the image is to remain visible. The power consumed during such constant refreshment of an image is a major drain on the battery. In contrast, an electro-phoretic display need only be written once, and thereafter the bistable medium will maintain the image for a substantial period without any refreshing, thus greatly reducing the power consumption of the display.

As the application of touch panel being more popular, the electro-phoretic display is required to have this feature. Although the electro-phoretic display only need be written once, when applied the touch feature, the data on the electro-phoretic display will be changed frequently. The electro-phoretic display has to be refreshed frequently; otherwise the touch sensibility of the display will be lower. Therefore, the electro-phoretic display with touch panel feature will consume much more power than electro-phoretic display without the touch feature.

### SUMMARY OF THE INVENTION

It is therefore a primary objective of the claimed invention to provide an electro-phoretic touch display with touch panel function to lower power consumption when updating the touched pixel display data.

The present invention discloses an electro-phoretic display comprising an electro-phoretic panel, a touch sensing module, for sensing a touch position, a column driver, a row driver, for selecting a row to be driven; and a controller, for determining an updating position according to the touch position; wherein, the column driver provides a data signal according to the updating position and the row driver provides a selecting signal according to the updating position such that a pixel corresponding to the updating position is updated.

The present invention also discloses an electro-phoretic display comprising an electro-phoretic panel, a touch sensing module, for sensing a touch position; a column driver, for providing a data signal; a row driver, for selecting a row to be driven; a controller, for controlling the column driver and the row driver; and a voltage provider, for providing a predetermining voltage to a pixel corresponding to the touch position to update the pixel.

The present invention further discloses a method of driving an electro-phoretic display comprising an electro-phoretic layer, a touch sensing module, a column driver and a row driver, the method comprising: utilizing the touch sensing module to sense a touch position; and updating a first pixel within a predetermined range of the touch position and ceasing providing power to a second pixel located outside the predetermined range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electro-phoretic display with the touch sensing controller and cascading data driver according to an embodiment of the present invention.

FIG. 2 is a schematic diagram of an electro-phoretic display with the touch sensing function embedded into controller and cascading data driver according to an embodiment of the present invention.

FIG. 3 is a schematic diagram of an electro-phoretic display with the touch sensing controller and point-to-point data driver according to an embodiment of the present invention.

FIG. 4 is a schematic diagram of an electro-phoretic display with the touch sensing function embedded into controller and point-to-point data driver according to an embodiment of the present invention.

FIG. 5 shows image pixels and touch sensing points according to an embodiment of the present invention.

FIG. 6 shows a touch position on image pixels of an electro-phoretic display according an embodiment of the present invention.

FIG. 7 shows a touch sensing module and an electro-phoretic layer according to an embodiment of the present invention.

FIG. 8 shows a touch sensing module of FIG. 7.

FIG. 9 shows a touch sensing module of FIG. 7.

FIG. 10 shows a touch sensing module of FIG. 7.

FIG. 11 shows a touch sensing module of FIG. 7.

FIG. 12 is a schematic diagram of a plurality micro-electro-mechanical system switches utilizing on an electro-phoretic display.

FIG. 13 is a schematic diagram of a plurality switches and a voltage provider utilizing on an electro-phoretic display.

FIG. 14 is a flow chart of an updating touched position method according to an embodiment of the present invention.

### DETAILED DESCRIPTION

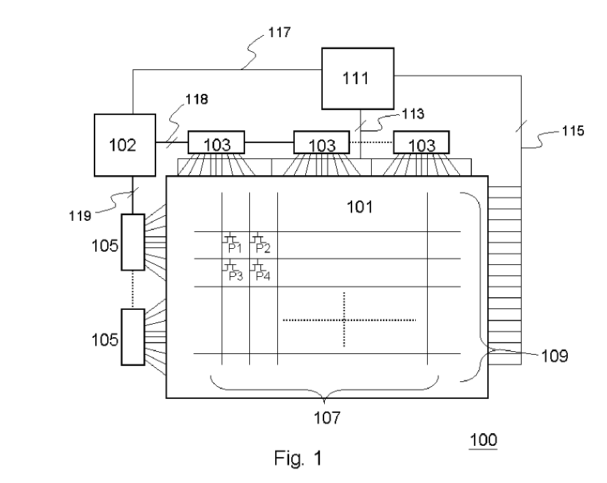

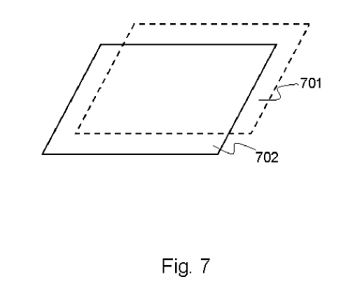

Please refer to FIG. 1 in conjunction with FIG. 7. FIG. 1 shows an electro-phoretic display system 100 according to a first embodiment of the present invention. As shown in FIG. 1, the electro-phoretic display system has a panel 101, a controller 102, a data driver 103, a selecting driver 105 and a touch sensing controller 111. FIG. 7 is a structure diagram according to the panel 101, which has two components, a touch sensing module 701 and an electro-phoretic layer 702. The electro-phoretic s layer has a plurality of pixels (e.g. P1, P2, P3, P4 . . . ), each pixel has a TFT transistor connected to a data line 107 and a selecting line 109. The selecting driver 105 turns on the TFT transistor and the data driver 103 sends an image data to the corresponding pixel. The touch sensing module 701 is used to sense a touch on the panel 101, and provides a touch sensing signal to the touch sensing controller 111 through the touch sensing signal lines 113 and 115. The touch sensing controller 111 receives the touch sensing signal and identifies a touch position according to the touch sensing signal, and then the touch sensing controller 111 sends the touch position to the controller 102 through a signal line 117.

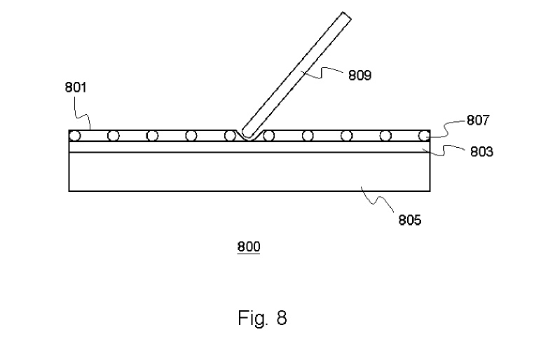

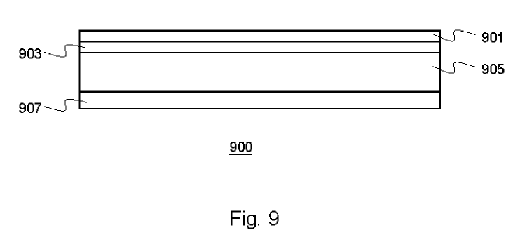

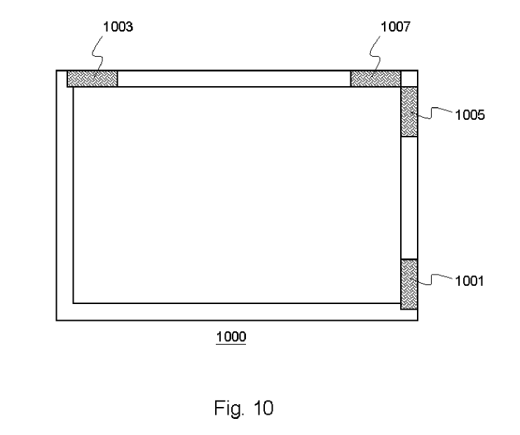

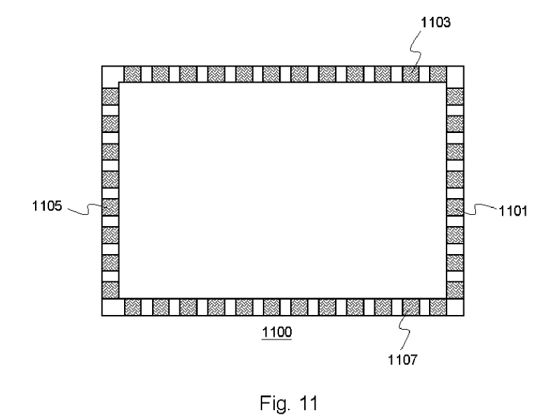

The touch sensing module 701 in FIG. 7 could be realized in many ways. Please refer to FIG. 8 to FIG. 11, which depict different types of touch sensing modules. As shown in FIG. 8, a resistive touch sensing module 800 is presented. The resistive touch sensing module 800 comprises an ITO film 801, an ITO glass 803, a display device 805 and spacer 807. The ITO film 801 is separated from the ITO glass 803 by a plurality of spacer 807. There is a voltage difference between the ITO film 801 and the ITO glass 803, when an object 809 touches the display, the place being touched will have a voltage change. Utilizing the voltage change, a touch position will be identified. Please refer to FIG. 9, which depicts a capacitive touch sensing module 900. As shown in FIG. 9, the capacitive touch sensing module 900 comprises a SiO₂ layer 901, an ITO layer 903, a glass layer 905 and an ITO layer 907. The SiO₂ layer 901 is used as a protection of the ITO layer 903. When an object touches the display, an electrical field will be established on the ITO layer 903. Utilizing the electrical field, a touch position will be identified. Please refer to FIG. 10, which depicts an acoustic touch sensing module. The acoustic touch sensing module 1000 comprises a first transmitter 1001, a second transmitter 1003, a first receiver 1005 and a second receiver 1007. The first transmitter 1001 and the second transmitter 1003 will transmit acoustic waves to form a uniform acoustic field on the display. When an object touches the display, the first receiver 1005 and the second receiver 1007 will receive the variance of the acoustic field, so as to identify the touch position. Please refer to FIG. 11, which depicts an optical touch sensing module 1100. The optical touch sensing module 1100 comprises a plurality of horizontal transmitters 1101, a plurality of vertical transmitters 1103, a plurality of horizontal receivers 1105 and a plurality of vertical receivers 1107. The plurality of horizontal transmitters 1101 and the plurality of vertical transmitters 1103 emit lights (e.g. infrared lights) to form a light matrix on the display. When an object touch the panel, the plurality of horizontal receivers 1105 and the plurality of vertical receivers 1107 will sense that touch (e.g. the emitted lights may be blocked), and identify the touch position. These touch sensing modules are examples of touch sensing modules, and should not limit the scope of this invention.

Please refer to FIG. 1 again. In this embodiment, the controller 102 can be a timing controller for sending data signals to the data driver 103 and sending timing control signals to the data driver 103 and the selecting driver 105. The data driver 103 is electrically coupled to the controller 102 through a plurality of data signal lines 118, and the selecting driver 105 is electrically coupled to the controller 102 through a plurality of selecting signal data lines 119. Please note, the data driver 103 shown in FIG. 1 could be a plurality of data drivers 103 for large display panel, or could be only one data driver 103 for small display panel. The selecting driver 105 could be plurality of drivers or only one driver as described above. When the display image is changed, the controller 102 sends the updating data and timing control signals to the data driver 103 and the selecting driver 105 for updating the new image on the panel 101. The selecting driver 105 turns on the selecting line 109 one by one (in some cases, the selecting line 109 can be turned on two by two or three by three), and the data driver 103 sends image data to the corresponding data line 107. A user can read a new frame of data by using above process.

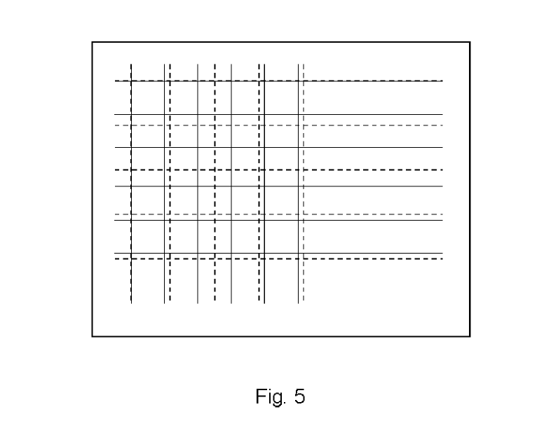

The controller 102 can also receive the touch position outputted by the touch sensing controller 111. In many cases, a resolution of image display (total display pixel counts) is higher than a resolution of a touch panel (total touch sensing point counts). As shown in FIG. 5, the solid grids are image pixels and the dotted grids are touch sensing points. In some of the pixels and points, there is misalignment existed. Of course, in some case, the resolution of image display can be equal or higher than the resolution of the touch panel, and that is also within the scope of this invention. In this case, the controller 102 identifies a nearby pixel according to the touch position. The nearby pixel is therefore corresponding to an updating position. The controller 102 then outputs an updated data according to the updating position. Please note, in this embodiment, when nearby pixel corresponding to the updating position is being updated, only one selecting line 109 corresponding to the nearby pixel is turned on, and only one data line 107 corresponding to the nearby pixel sends the image data to the nearby pixel. Unlike the traditional driving method, a whole frame of pixels needs to be driven when new image data needs to be displayed. According to this invention, only one pixel corresponding to the updating position needs to be driven, so the power consumption will be lower. The touch sensing controller 111 can process the touch position and identify the nearby pixel, then output the updating position according to the position of the nearby pixel to the controller 102. The controller 102 receives the updating position and only needs to update the nearby pixel according the updating position. In a case that the image pixels have the same position to the touch points, the touch position is equal to the updating position.

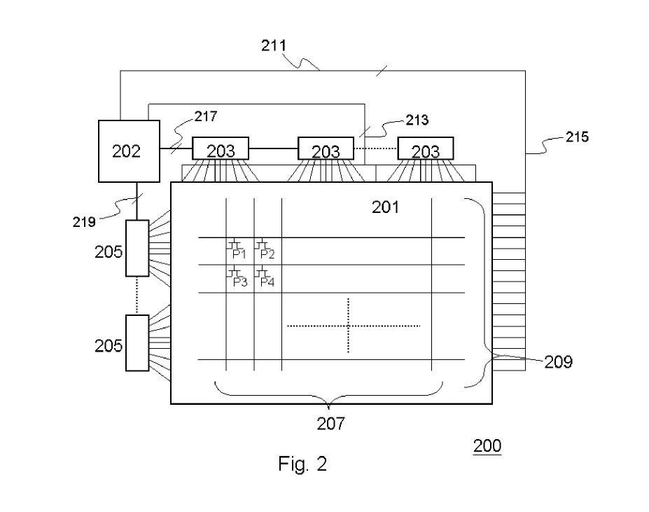

FIG. 2 shows an electro-phoretic display system 200 according to a second embodiment of the present invention. The difference between the first embodiment and the second embodiment is the touch sensing controller 111 of the first embodiment embedded into the controller 202 of the second embodiment. When the display image is changed, the controller 202 sends the updating data and timing control signals to a data driver 203 and sends timing control signals to a selecting driver 205 for updating the new image on a panel 201. The selecting driver 205 turns on a selecting line 209 one by one (in some cases, the selecting line 209 can be turned on two by two or three by three), and the data driver 203 sends image data to the corresponding data line 207. When the panel 201 is touched, the controller 202 senses a touch sensing signal to determine a touch position. And then the controller 202 determines an updating position (corresponding to a pixel located at the touch position or an above-mentioned nearby pixel). The following steps are similar to the first embodiment, and will not narrate here again.

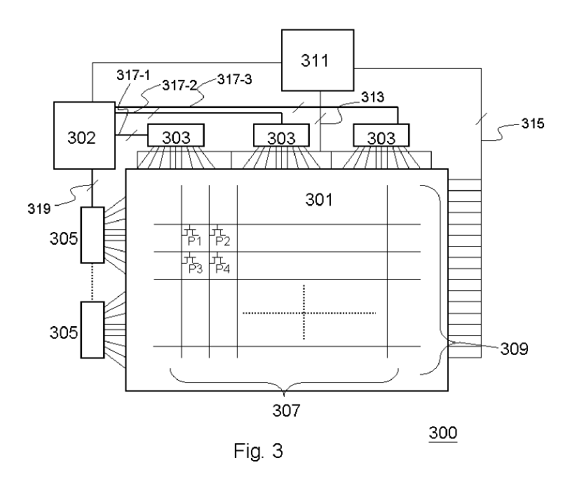

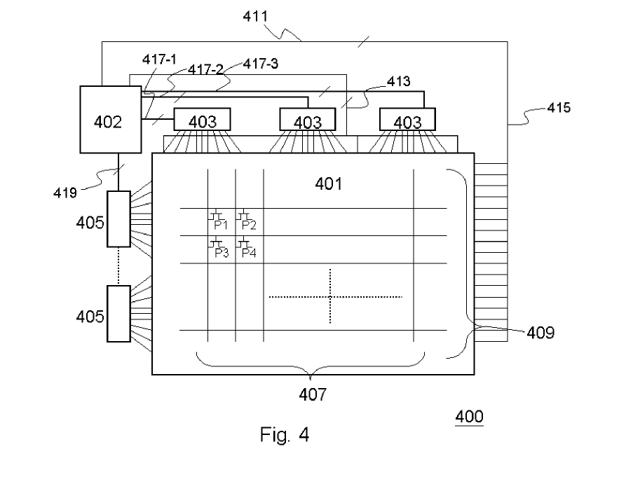

FIG. 3 and FIG. 4 show third and fourth embodiments of the present invention. The third embodiment is corresponding to the first embodiment, and the fourth embodiment is corresponding to the second embodiment. The only difference between the third embodiment and the first embodiment is that in the first embodiment, the controller 102 is connected to the first data driver 103 (the leftist one), and the second data driver (the one on the right side of the leftist one) is connected to the first data driver 103. The controller 102 sends the data signals to the first data driver 103, and the first data driver 103 passes the data signals to the second data driver 103. But in the third embodiment, the controller 302 is connected to the first data driver 303 (the leftist one) and the second data driver 303 (the one on the right side of the leftist one) directly. The controller 302 directly sends the data signals to the first data driver 303 and the second data driver 303. The difference between the fourth embodiment and the second embodiment is similar to the difference between the third embodiment and the first embodiment, and will not narrate here again.

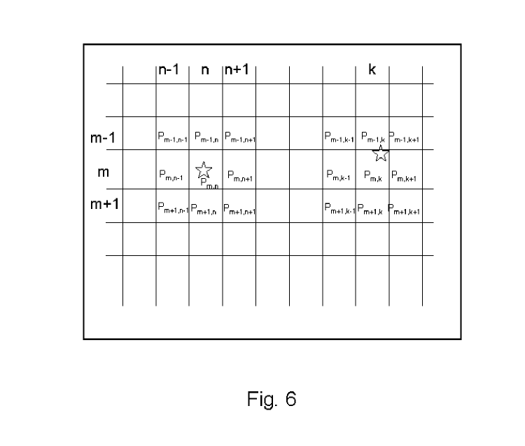

When an object touches the panel, the object may touch on the center of a pixel or between two or more pixels as shown in FIG. 6. In FIG. 6, the star sign is a touch position. When the touch position is on the center of pixel P_{m,n}, the controller 102 (202, 302, 402) updates the value of the pixel P_{m,n}. So other pixels which are not touched are not necessary to be updated in order to lower the power consumption. When the touch position is on two or more pixels, as shown in FIG. 6, the touch position is on the pixels P_{m-1,k} and P_{m,k}, the controller 102 (202, 302, 402) updates both of the pixels P_{m-1,k} and P_{m,k}. Please note, the above-mentioned updating mechanism is only regarded as an embodiment, not a limitation of the present invention. Actually, the controller 102 (202, 302, 402) can be designed according to different demands. For example, a designer can also utilize the controller 102 (202, 302, 402) to update the pixel P_{m,k} since the area being touched on P_{m,k} is larger than on P_{m-1,k}, or randomly update one of these two pixels. In some cases, when an object touches the panel, the data of the touched pixel and pixels nearby the touched pixel will be affected because of the touch. The controller 102 (202, 302, 402) can be designed to update a predetermined range of pixels nearby the touch pixel.—For example, when the pixel P_{m,n} is being touched, the nine pixels from P_{m-1,n-1} P_{m+1,n+1} will be updated. These changes all obey the spirit of the present invention.

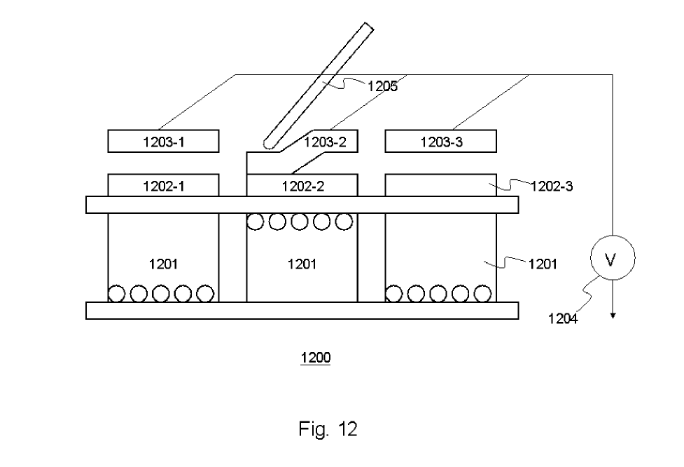

Another method to update the touched pixel is utilizing a micro-electro-mechanical system switch. As shown in FIG. 12, an electro-phoretic display 1200 comprises a plurality of pixels 1201, a plurality of pixel electrodes 1202-1˜1202-3, a plurality of micro-electro-mechanical system switches 1203-1˜1203-3 and a voltage provider 1204. When an object 1205 touches the display, a pressure under the object 1205 causes the micro-electro-mechanical system switch 1203-2 connecting to the pixel electrode 1202-2, so the voltage provider 1204 can provide voltage to the pixel to update the touched pixel value. The micro-electro-mechanical system switch can be combined with a touch sensing module if the touch position is required, or without the touch sensing module if the touch position is not required. The touch sensing module can refer to FIG. 8 to FIG. 11 and corresponding description are similar as above. The electro-phoretic display 1200 with micro-electro-mechanical system switch can be used in the first to fourth embodiments corresponding to FIG. 1 to FIG. 4 respectively. The details of the first to fourth embodiments are the same, and will not be narrated here again.

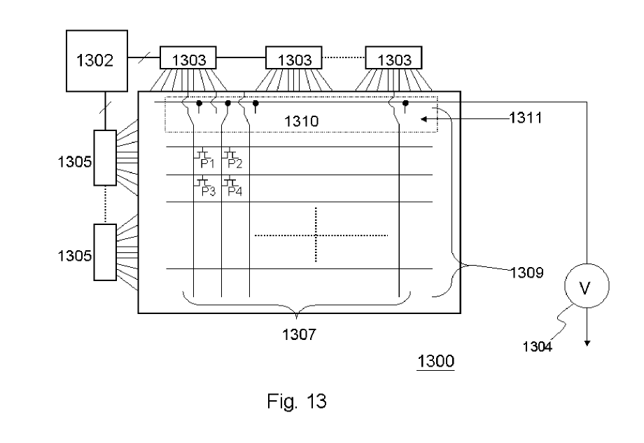

FIG. 13 is another embodiment to update a pixel being touched. As shown in FIG. 13, an electro-phoretic display 1300 comprises a data driver 1303, a selecting driver 1305, a controller 1302, a plurality of data lines 1307, a plurality of selecting lines 1309, a voltage provider 1304 and a plurality of switches 1310. When the display is touched, a switch control signal 1311 connects the corresponding data line 1307 to the voltage provider 1304 and the controller 1302 turns on the corresponding selecting line 1309 by the selecting driver 1305. So the pixel being touched can be updated by the voltage provider 1304. The switch control signal 1311 is generated according to a touch position, and the touch position is generated by a touch sensing module. The touch sensing module can refer to FIG. 8 to FIG. 11 and corresponding description are similar as above. The electro-phoretic display 1300 with switches can be used in the first to fourth embodiments corresponding to FIG. 1 to FIG. 4 respectively. The details of the first to fourth embodiments are the same, and will not be narrated here again.

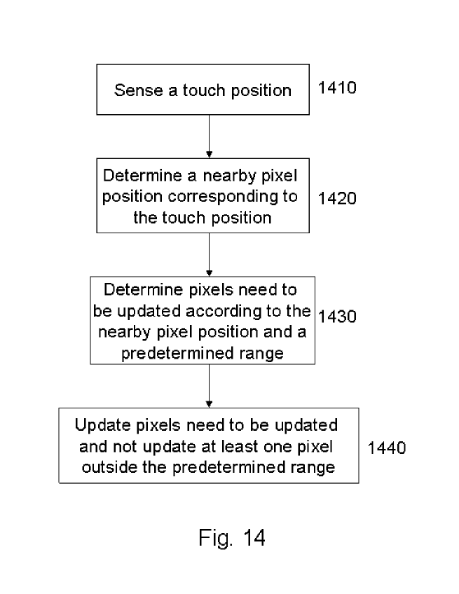

FIG. 14 shows a flowchart of updating a pixel being touched on an electro-phoretic display according to the present invention. As shown in step 1410, the electro-phoretic display senses a touch position. After the electro-phoretic display receives the touch position, the display determines a nearby pixel position corresponding to the touch position as shown in step 1420. It should be noted that in some case the nearby pixel position is equal to the touch position, and the step 1420 may be omitted therefore. The electro-phoretic display then determines pixels need to be updated (corresponding to the updating position) according to the nearby pixel position and a predetermined range as shown in step 1430. It should be noted that the predetermined range could be several pixels around the nearby pixel, or the predetermined range could be only one pixel which is the nearby pixel itself. The electro-phoretic display then updates the pixels need to be updated but does not update at least one pixel outside the predetermined range as shown in step 1440. It should be noted that at least one pixel outside the predetermined range is not updated (for example, the power is not supplied to the pixel) for lowering the power consumption. In an embodiment, the pixels outside the predetermined range are not updated. This can reduce more power consumption. But, in another embodiment, part of the pixels outside the predetermined range can be updated according to special need, e.g. clock information display area needs to be updated.

To sum up, the present invention provides the novel electro-phoretic display with touch panel functions, which can reduce more power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electro-phoretic display comprising:
an electro-phoretic panel;
a touch sensing module, for sensing a touch position;
a column driver;
a row driver, for selecting a row to be driven; and
a controller, for determining an updating position according to the touch position;
wherein, the column driver provides a data signal according to the updating position and the row driver provides a selecting signal according to the updating position such that a pixel corresponding to the updating position is updated.

2. The electro-phoretic display of claim 1, wherein the column driver and the row driver also updates data of pixels around the updating position.

3. The electro-phoretic display of claim 1, wherein the updating position is equal to the touch position.

4. The electro-phoretic display of claim 1, wherein the updating position is close to the touch position.

5. The electro-phoretic display of claim 1, wherein the electro-phoretic display further comprises a timing controller electrically connected to the controller, the column driver and the row driver, for providing timing signal to the column driver and the row driver such that the column driver provides the data signal according to the updating position and the row driver provides the selecting signal according to the updating position.

6. The electro-phoretic display of claim 1, wherein the controller electrically connected to the touch sensing module, and generating the updating position according to a touch sensing signal of the touch sensing layer.

7. The electro-phoretic display of claim 1, wherein the controller is coupled to the column driver and the row driver, for further providing timing signal to the column driver and the row driver such that the column driver provides the data signal according to the updating position and the row driver provides the selecting signal according to the updating position.

8. An electro-phoretic display comprising:
an electro-phoretic panel;
a touch sensing module, for sensing a touch position;
a column driver, for providing a data signal;
a row driver, for selecting a row to be driven;
a controller, for controlling the column driver and the row driver; and
a voltage provider, for providing a predetermining voltage to a pixel corresponding to the touch position to update the pixel.

9. The electro-phoretic display of claim 8, wherein the touch sensing module comprises at least one switch, for electrically connecting the column driver or the voltage provider to the pixel of the electro-phoretic display.

10. The electro-phoretic display of claim 9, wherein the controller further controls the switch according to the touch position

11. The electro-phoretic display of claim 8, wherein the touch sensing module comprises at least one switch, for electrically connecting the voltage provider to the pixel of the electro-phoretic display.

12. The electro-phoretic display of claim 11, wherein the switch is a micro-electro-mechanical system switch.

13. The electro-phoretic display of claim 8, wherein the electro-phoretic display comprises a touch sensing controller electrically connected to the touch sensing module, for receiving a touch position signal corresponding to the touch position.

14. The electro-phoretic display of claim 8, wherein the controller electrically connected to the touch sensing module, for receiving a touch position signal corresponding to the touch position.

15. A method of driving an electro-phoretic display comprising an electro-phoretic layer, a touch sensing module, a column driver and a row driver, the method comprising:
utilizing the touch sensing module to sense a touch position;
updating a first pixel within a predetermined range of the touch position and ceasing providing power to a second pixel located outside the predetermined range.

16. The method of claim 15, wherein the step of updating the first pixel comprises:
utilizing a fixed voltage to update the first pixel.

17. The method of claim 16, wherein the electro-phoretic display further comprises a switch, coupled the first pixel and the fixed voltage, and the step of utilizing the fixed voltage to update the first pixel further comprises:
controlling the switch to connect the fixed voltage to the first pixel to update the first pixel.

18. The method of claim 15, wherein the electro-phoretic display further comprises a controller, and the step of updating the first pixel comprises:
utilizing the controller to receive the touch position and provides a driving data to the column driver such that the first pixel is updated.

19. The method of claim 15, wherein a plurality of first pixels within the predetermined range of the touch position are updated.
